(19) United States
(12) Patent Application Publication
(10) Pub. No.: US 2015/0163325 A1
(43) Pub. Date: Jun. 11, 2015

(54) METHOD, DEVICE AND SYSTEM FOR INFORMATION TRANSMISSION

(71) Applicant: TENCENT TECHNOLOGY (SHENZHEN) COMPANY LIMITED, Shenzhen (CN)

(72) Inventors: Xiaolong Zhang, Shenzhen (CN); Yi Shan, Shenzhen (CN)

(73) Assignee: Tencent Technology (Shenzhen) Company Limited, Shenzhen (CN)

(21) Appl. No.: 14/626,246

(22) Filed: Feb. 19, 2015

Related U.S. Application Data
(63) Continuation of application No. PCT/CN2014/085380, filed on Aug. 28, 2014.

(30) Foreign Application Priority Data
Sep. 18, 2013 (CN) 201310429120.9

(51) Int. Cl. H04L 29/06

(52) U.S. Cl. CPC H04L 67/42

(57) ABSTRACT

A method, device and system for information transmission are provided. The method comprises steps of: logining, by a client with a processor, into a server with a first communication type through a first communication account; getting, by the client with the processor, a second communication account of a second communication type wherein the second communication account is not in a friend list of the first communication account and does not accept an invitation request from the client; receiving, from a user interface, by the client with the processor, first information carrying the second communication account wherein the first information is input by a user using the user interface; and transmitting, by the client with the processor, the first information to the server, and transmitting, by the server, the first information to the client corresponding to the second communication account.

### CROSS-REFERENCE TO RELATED APPLICATIONS

This application is a continuation of International Application No. PCT/CN2014/085380, filed on Aug. 28, 2014, which claims priority to Chinese Patent Application No. 201310429120.9, filed on Sep. 18, 2013, both of which are incorporated by reference in their entireties.

### FIELD OF THE TECHNOLOGY

The present disclosure relates to the field of interne technology, particularly to a method, device and system for information transmission.

### BACKGROUND OF THE TECHNOLOGY

Nowadays, various types of communications appear in our life, such as instant communication, SNS (Social Networking Services) communication, telephone (including mobile phone, fixed telephone and network telephone) communication and email communication. However, an instant communication account can transmit information only with another instant communication account; a telephone communication account can transmit information only with another telephone communication account; and email communication account can transmit information only with another email communication account.

Users may use communication accounts of various types practically. For example, user A has got used to communicate on an instant communication account, while user B has got used to a telephone communication account. Thus, user A has to quit the instant communication account and login a telephone communication account before he/she transmits information with user B.

### SUMMARY

The examples of this disclosure provide a method, device and system for information transmission, which makes it possible to transmit information between the communication accounts of the different types.

According to one aspect of the disclosure, the examples of this disclosure provide a method for information transmission, which may include the steps of:

Logging in, by a client with a processor, into a server with a first communication type through a first communication account; getting, by the client with the processor, a second communication account of a second communication type wherein the second communication account is not in a friend list of the first communication account and does not accept an invitation request from the client; receiving, from a user interface, by the client with the processor, first information carrying the second communication account wherein the first information is input by a user using the user interface; and transmitting, by the client with the processor, the first information to the server for the server to transmit the first information to the client corresponding to the second communication account.

According to another aspect of the disclosure, the examples of this disclosure provide a client for information transmission, which includes one or more processors, a memory, a login unit, a first acquisition unit, a receiving unit and a transmitting unit.

The login unit having the one or more processors coupled with the memory that is used to login into a server of a first communication type through a first communication account; the first acquisition unit having the one or more processors coupled with the memory that is used to get a second communication account of a second communication type wherein the second communication account is not in a friend list of the first communication account and does not accept an invitation request from the client; the receiving unit having the one or more processors coupled with the memory that is used to receive first information from a user interface carrying the second communication account wherein the first information is input by a user using the user interface; and the transmitting unit having the one or more processors coupled with the memory that is used to transmit the first information to the server so that the server transmits the first information to the client corresponding to the second communication account.

According to another aspect of the disclosure, the examples of this disclosure provide a system for information transmission, comprising a client with one or more processors coupled with a memory and a server with one or more processors couple with a memory.

The client is used to: login into the server of a first communication type through a first communication account, get a second communication account of a second communication type, wherein the second communication account is not in a friend list of the first communication account and has does not accept an invitation request from the client, receive first information from a user interface carrying the second communication account wherein the first information is input by a user using the user interface, and transmit the first information to the server; and the server is used to: transmit the first information to the client corresponding to the second communication account.

The technical scheme comprises steps of: logining, by a client, into a server of the first communication type through the first communication account; getting, by the client, the second communication account of the second communication type, which is not in friend list of the first communication account and has not accepted invitation request from the client; receiving, from a user interface, by the client, the first information which is input by the user and carries the second communication account; transmitting, by the client, the first information to the server, and transmitting, by the server, the first information to the client corresponding to the second communication account. Thus, communication transmission between the first communication account and the second communication account is realized, and it is now possible to transmit information between communication accounts of different types and meet the requirement of users.

### BRIEF DESCRIPTION OF THE DRAWINGS

Accompanying drawings used in the description of the examples and prior art are briefly introduced to make further illustration on the technical scheme of the examples of this disclosure and prior art. It is apparent that the described drawings are only for specific examples of this disclosure. Person of skill in the art may get other drawings according to these drawings without any creative labor.

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 shows the flow diagram of a method for information transmission provided by the examples of this disclosure.

FIG. 2 shows the flow diagram of another method for information transmission provided by the examples of this disclosure.

FIG. 3 shows the diagram of another method for information transmission provided by the examples of this disclosure.

FIG. 4 shows the diagram of example provided by the examples of this disclosure.

FIG. 5 shows the structural diagram of a client for information transmission provided by the examples of this disclosure.

FIG. 6 shows the structural diagram of another client for information transmission provided by the examples of this disclosure.

FIG. 7 shows the structural diagram of another client for information transmission provided by the examples of this disclosure.

FIG. 8 shows the structural diagram of a system for information transmission provided by the examples of this disclosure.

### DETAILED DESCRIPTION OF ILLUSTRATED EXAMPLES

The principles described herein may be embodied in many different forms. Not all of the depicted components may be required, however, and some implementations may include additional components. Variations in the arrangement and type of the components may be made without departing from the spirit or scope of the claims as set forth herein. Additional, different or fewer components may be provided.

Reference throughout this specification to “one example,” “an example,” “examples,” “one embodiment,” “an embodiment,” “example embodiment,” or the like in the singular or plural means that one or more particular features, structures, or characteristics described in connection with an embodiment or an example is included in at least one embodiment or one example of the present disclosure. Thus, the appearances of the phrases “in one embodiment,” “in an embodiment,” “in an example embodiment,” “in one example,” “in an example,” or the like in the singular or plural in various places throughout this specification are not necessarily all referring to the same embodiment or the same example. Furthermore, the particular features, structures, or characteristics may be combined in any suitable manner in one or more embodiments or examples.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the terms “module,” “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers configured to provide certain server functionalities, such as database management and search engines. A server may also include one or more processors to execute computer programs in parallel.

It should be noticed that, the embodiments/examples and the features in the embodiments/examples may be combined with each other in a no conflict condition. This disclosure will become apparent from the following detailed description when taken in conjunction with the accompanying drawings.

It should be noticed that, the steps illustrated in the flowchart of the drawings may be performed in a set of computer device with executable program codes. And the order of the steps may be different from that in the drawings under some status, although a logic order is shown in the flowchart.

Other aspects, features, and advantages of this disclosure will become apparent from the following detailed description when taken in conjunction with the accompanying drawings. Apparently, the examples described thereinafter merely a part of examples of the present disclosure, but not all examples. Persons skilled in the art may obtain all other examples without creative works, based on these examples, which pertains to the protection scope of the present disclosure.

The examples of the present disclosure provide a data processing method for backing up and restoring data, which may selectively recover the data so as to improve the efficiency of data recovery. The examples of the present disclosure also provide a corresponding terminal and produce. The details are described respectively in the following.

Clear and complete description is made on the technical scheme in the examples of this disclosure, combining with the drawings of the examples of this disclosure. Obviously, the examples are only described partly below, rather than all of them. Any other example made by person of skill in the art without creative labor is in the scope of this disclosure.

In the examples of this disclosure, the client is the client module in terminal device, such as instant communication client, social network system (SNS) client, user of email and so on, in which the terminal device may be personal computer (PC), tablet, mobile phone, intellectual phone, laptop and so on.

The communication type may be any communication type in the field of internet technique, such as, communication of instant communication, SNS, telephone, email or the like. Therein the first communication type may be any communication type in the field of internet technique and the second communication type may be any communication type except for the type of the first communication in the field of internet technique. For example, in case that the first communication is of the instant communication type, the type of the second communication may be one among the types of SNS, telephone and email. Therein, the first communication account may be any communication account of the first communication type above and the second communication account may be any communication account of the second communication type above.

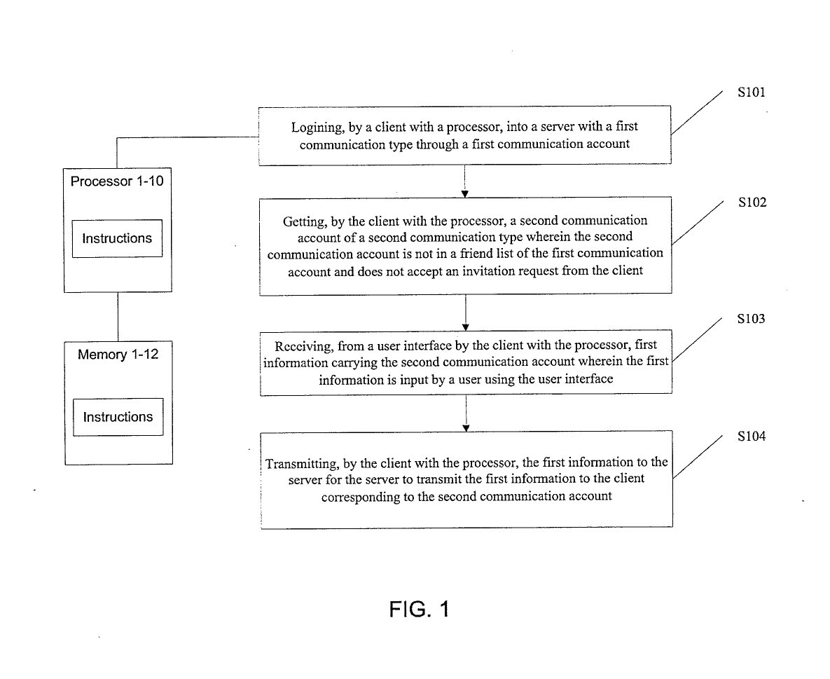

FIG. 1 shows the flow diagram of a method for information transmission provided by the examples of this disclosure. As shown in FIG. 1, the method comprises steps of:

S101, Logining, by a client with a processor, into a server with a first communication type through a first communication account;

S102, Getting, by the client with the processor, a second communication account of a second communication type wherein the second communication account is not in a friend list of the first communication account and does not accept an invitation request from the client;

Preferably, the description that the second communication account is not in friend list of the first communication account and has not accepted invitation request from the client means that before the step 102, the client has no information transmission with the second communication account, or the client has not stored any record of information transmission with the second communication account, or the second communication account has not transmitted any information with the first communication account before the step S102, or the first communication account has not stored any record of information transmission with the second communication account.

S103, Receiving, from a user interface, by the client with the processor, first information carrying the second communication account wherein the first information is input by a user using the user interface;

Preferably, the information above may be text information, image information, audio information and the like. But the information is not limited in the example.

The user interface may be any interface that user may use to input information. The user interface may be touch screen or keyboard input, or voice recognition system. The user interface enables the user to input the first information.

S104, transmitting, by the client with the processor, the first information to the server for the server to transmit the first information to the client corresponding to the second communication account.

Preferably, when the server receives the first information, it will transmit the first information to the client corresponding to the second communication account. Specifically, the server transmits the first information to a server of the second communication type and then the server transmits the information to the client corresponding to the second communication account. Therein, the client corresponding to the second communication account may be the client used by the second communication account to login in the server of the second communication type.

Through steps above, the information transmission between communication accounts of different types will be realized. For example, when the first communication is of instant communication type and the second communication is of telephone type, an instant communication account can transmit information to a telephone account (for example: telephone number). Practically, it is free to transmit information on a communication account of instant communication type, while not on that of telephone type. Through steps above, it will be free of charge to transmit information to telephone account (for example, telephone number).

Besides, in practical application, information of telephone account (for example, telephone number) always draws much more attention than that of instant communication account. Therefore, it enables users to view information instantly by transmitting information to telephone account (for example, telephone number) through steps above.

The technical scheme comprises steps of logining, by a client, into a server of the first communication type through the first communication account; getting, by the client, the second communication account of the second communication type, in which the second communication account is not in friend list of the first communication account and has not accepted invitation request from the client; receiving, by the client, the first information which is input by the user and carries the second communication account; transmitting, by the client, the first information to the server, and transmitting, by the server, the first information to the client corresponding to the second communication account.

Thus, the communication transmission between the first communication account and the second communication account may be realized and it is possible to transmit information between communication accounts of different types and meet the requirement of users.

All steps shown in FIG. 1 may be performed by executing instructions stored in the memory 1-12 by the processor 1-10.

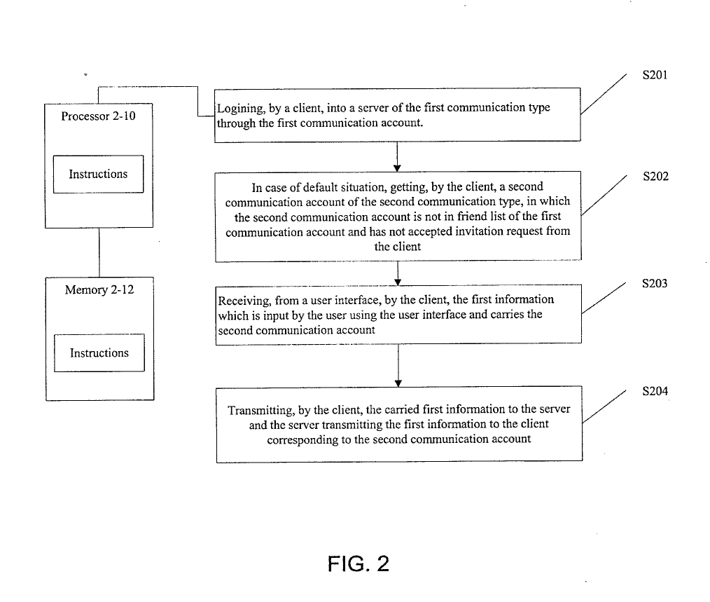

FIG. 2 shows the flow diagram of another method for information transmission provided by the examples of this disclosure. As shown in FIG. 2, the method comprises steps as below:

S201, logining, by a client with a processor, into a server of the first communication type through the first communication account.

S202, in case of default situation, getting, by the client, a second communication account of the second communication type, in which the second communication account is not in friend list of the first communication account and has not accepted invitation request from the client.

Preferably, the default situation may be the situation in which the client receives an indication message that the third communication account in the friend list of the first communication account cannot accept information; the second communication account and the third communication type are communication accounts of the second communication type, which are registered by a same user and the second communication account is not in friend list of the first communication account, and the second communication account may not accept invitation request from the client; or,

The client transmits a second information to the forth communication account in friend list of the first communication account and starting timing; and the client does not accept the response information, returned by the forth communication account, of the second information with a preset time period; or, the second communication account transmits the first information in an emergency.

All situations above only intend to illustrate the disclosure. Default situations of the example include, but are not limited to, the situations above.

For example, before the step S202, the method may comprise a step of:

The client getting an indication message indicating that the third communication account in friend list of the first communication account cannot accept information; and the second communication account and the third communication type are communication accounts of the second communication type, in which the communication accounts are registered by a same user and the second communication account may not be in friend list of the first communication account, and may not accept invitation request from the client.

Specifically, the indication message may be obtained in measurement of the client, or transmission from the server to the client.

Therefore, it can transmit the first information, which is under transmission to the third communication account, to the second communication account of the user, in case that the third communication account cannot accept information.

For example, in case that the user does not use the third communication account to login in the server, or there is network anomaly on the third communication account, but network of the second communication account is normal. For example, the user at a terminal uses the third communication account (for example: an instant communication account) to login in the server through wireless network, and logins in the server of the second communication type through mobile network using the second communication account (for example: mobile phone number). In case that anomaly happens to the wireless network and the third communication account (for example: an instant communication account) cannot accept information, the example can transmit the first information to the second communication account (for example: mobile phone number), namely the user is enabled to receive the first information instantly.

For example, before the step S202, the method may also comprise a step of the client transmitting a second information to the forth communication account in friend list of the first communication account and starting timing; in case that the client cannot accept the response information returned by the forth communication account within the preset time, executing the step S202; therein, the second communication account and the forth communication account are communication accounts registered by a same user.

Therein, content of the second information may be same or different with that of the first information. Therefore, the step S202 will be executed in case that the forth communication account does not return the response information within a certain time.

For example, in case that within 1 minute after the second information is transmitted to the forth communication account, no response information returned from the forth communication account is received, step S202 will be executed.

For example, a user logins in the second communication account and the forth communication account at a same time, but the user may be using the client corresponding to the second communication account, rather than that corresponding to the forth communication account, the user can receive the first information using the client corresponding to the second communication account.

S203, receiving, from a user interface, by the client, the first information which is input by the user using the user interface and carries the second communication account.

Preferably, the step S203 comprises: displaying, by the client a dialogue interface for communication with the second communication account, and receiving the first information which is input by the user on the interface and carries the second communication account.

Therefore, information transmission to the second communication account will be same with that to friend account of the first communication account, which simplifies the operation of user.

S204, transmitting, by the client, the carried first information to the server and the server transmitting the first information to the client corresponding to the second communication account.

Preferably, after getting the second communication account, the client may take the second communication account as a friend account of the first communication account and the client may transmit the information above to the server by friend account of the first communication account transmitting information.

For example, display a dialogue interface, input the first information on the dialogue interface and then transmit the first information to the server.

Preferably, the step S202 may comprise: the client getting a locally stored second communication account of the second communication type, wherein the second communication account is not in friend list of the first communication account and may not accept invitation request.

For example, to get the second communication account in contact of the terminal, in which the client locates, may mean specifically that the client displays the contact interface of the terminal, in which the client locates, and then receives the second communication account selected on the interface by user.

Preferably, the step S201 may comprise: the client getting an online second communication account of the second communication type, in which the second communication account is not in friend list of the first communication account and may not accept invitation request, for example, getting the second communication account transmitted by friend of the first communication account, or receiving the second communication account transmitted by the server. Of course, the second communication account may be a communication account input by user.

Various optional execution modes are introduced on basis of the above examples in the technical scheme, all of which can realize information transmission between the communication accounts of the different types.

Steps in FIG. 2 may be performed by one or more processors 2-10 to execute instructions stored in memory 2-12.

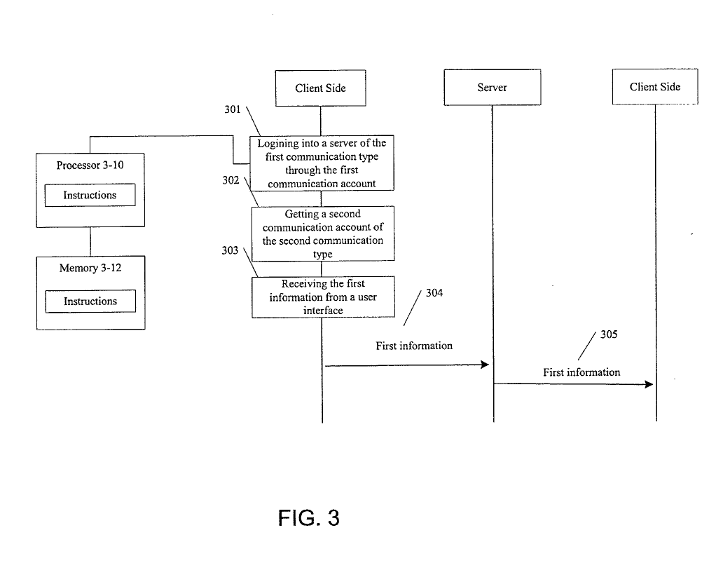

FIG. 3 shows the diagram of another method for information transmission provided by the examples of this disclosure. As shown in FIG. 3, it comprises the steps as below.

S301, logining, by a client, into a server of the first communication type through the first communication account.

S302, getting, by the client, a second communication account of the second communication type, in which the second communication account is not in friend list of the first communication account and may not accept invitation request from the client.

Preferably, the description that the second communication account is not in friend list of the first communication account and may not accept invitation request from the client means that before the step 302, the client has no information transmission with the second communication account, or the client has not stored any record of information transmission with the second communication account, or the second communication account has not transmitted any information with the first communication account before the step S302, or the first communication account has not stored any record of information transmission with the second communication account.

S303, receiving, by the client, the first information which is input by the user and carries the second communication account.

Preferably, the information above may be text information, image information, audio information and the like, which is not limited in the example.

S304, transmitting, by the client, the first information to the server.

S305, transmitting, by the server, the first information to the client corresponding to the second communication account.

Specifically, the client corresponding to the second communication account may be the client which the second communication account uses to login in server of the second communication type.

Preferably, before the step 302, the method may also comprise a step of: getting, by the client, an indication message that the third communication account in friend list of the first communication account may not accept information; and the second communication account and the third communication type are communication accounts of the second communication type, wherein the communication accounts are registered by a same user and not in friend list of the first communication account, and may not accept invitation request from the client.

Preferably, before the step 302, the method may also comprise steps of: The client transmitting a second information to the forth communication account in friend list of the first communication account and starting timing; in case that the client may not accept the response information returned by the forth communication account within the preset time, executing the step S302, wherein, the second communication account and the forth communication account are communication accounts registered by a same user.

Preferably, the step S302 may specifically comprise: getting, the client, a locally stored second communication account of the second communication type, in which the second communication account is not in friend list of the first communication account and may not accept invitation request; or getting, the client, an online second communication account of the second communication type, in which the second communication account is not in friend list of the first communication account and may not accept invitation request.

Preferably, the step S303 may specifically comprise: displaying, by the client, a dialogue interface for communication with the second communication account and receiving the first information which is input by the user on the interface and carries the second communication account.

Therefore, information transmission to the second communication account will be same with that to friend account of the first communication account and this simplifies the operation of user.

Steps shown in FIG. 3 may be performed by one or more processors 3-10 to execute instructions 3-10 stored in memory 3-12.

The technical scheme comprises steps of: logining, by a client, into a server of the first communication type through the first communication account; getting, by the client, the second communication account of the second communication type, in which the second communication account is not in friend list of the first communication account and may not accept invitation request from the client; receiving, from a user interface, by the client, the first information which is input by the user using the user interface and carries the second communication account; transmitting, by the client, the first information to the server; and the server transmitting the first information to the client corresponding to the second communication account. Thus, communication transmission between the first communication account and the second communication account is realized and now it is possible to transmit information between communication accounts of different types and meet the requirement of users.

A specific example is described to illustrate the method.

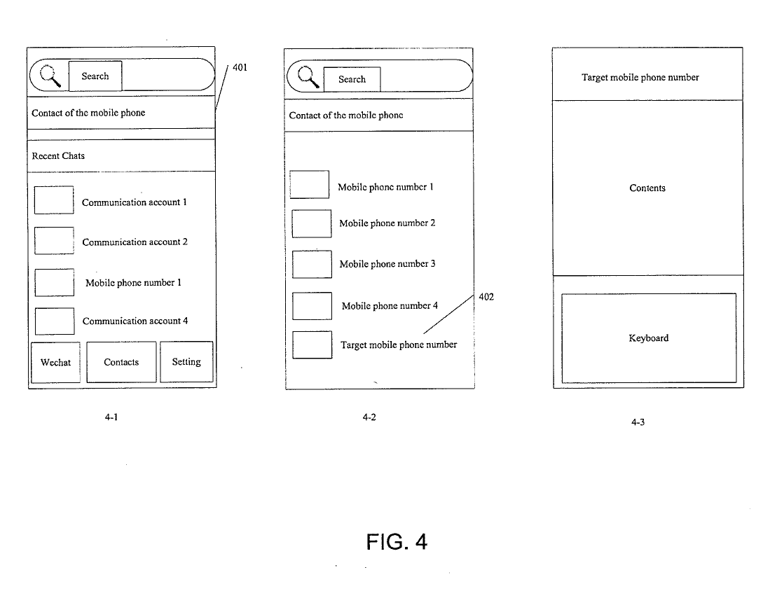

An instant communication account (the above first communication account) uses an instant communication client to login on an instant communication server, in order to obtain an interface as shown in FIG. 4-1. The interface contains contact 401 button for connecting with mobile phone and, by clicking the button, local contact of mobile phone will be displayed.

Specifically, an interface as shown in FIG. 4-2 will be obtained and it contains target mobile phone number (the second communication account above) 402. The client displays a dialogue interface as shown in FIG. 4-3, which is the interface for communication between the instant communication account and the target mobile phone number 402. Besides, the interface displays the target mobile phone number to get clearly aware that it is the target mobile phone number 402 that the instant communication account is communicating with. When the user finishes edition of information on the dialogue interface, the client will transmit the information and the target mobile phone number 402 to the server, and then the server will transmit the information to the target phone number 402. Therefore, information transmission to mobile phone number on an instant communication client can be realized.

The examples of the device will be described below. The examples of the device in accordance with this disclosure are used to execute the method introduced in the first to third example method. In order to simplify the introduction, only the part related to the examples of this disclosure will be exhibited. Reference may be made to the first, second and third example to get the undisclosed technical detail.

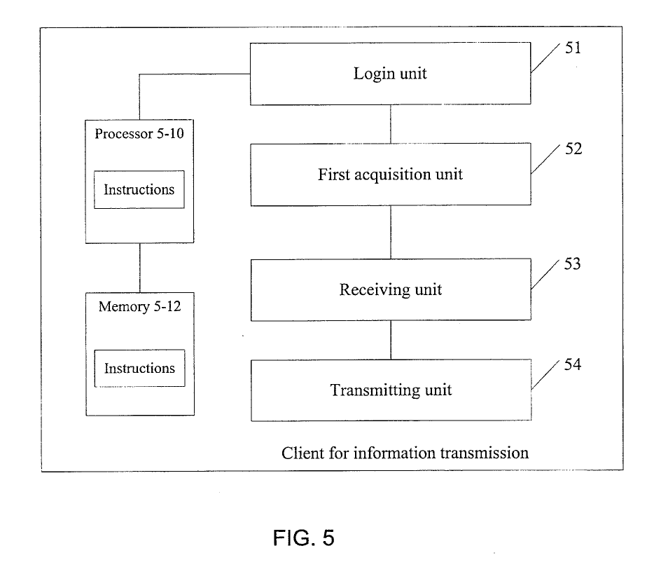

FIG. 5 shows the structural diagram of a client for information transmission provided by the examples of this disclosure. As shown in FIG. 5, the client is composed with a login unit 51, a first acquisition unit 52, a receiving unit 53 and a transmitting unit 54. Units shown in FIG. 5 may have one or more processors 5-10 to execute instructions stored in memory 5-12.

The login unit 51 is used to login into a server of the first communication type through the first communication account.

The first acquisition unit 52 is used to get the second communication account of the second communication type, in which the second communication account is not in friend list of the first communication account and may not accept invitation request from the client.

Preferably, the description that the second communication account is not in friend list of the first communication account and may not accept invitation request from the client means that before the first acquisition unit 52 gets the second communication account, the client has no information transmission with the second communication account, or the client has not stored any record of information transmission with the second communication account, or the second communication account has not transmitted any information with the first communication account before the first acquisition unit 52 gets the second communication account, or the first communication account has not stored any record of information transmission with the second communication account.

The receiving unit 53 is used to receive the first information which is input by the user and carries the second communication account. Preferably, the information above may be text information, image information, audio information and the like, which is not limited in the example.

The transmitting unit 54 is used to transmit the first information to the server so that the server transmits the first information to the client corresponding to the second communication account.

Preferably, when the server receives the first information, it will transmit the first information to the client corresponding to the second communication account. Specifically, the server transmits the first information to a server of the second communication type and then the server transmits the information to the client corresponding to the second communication account. Therein, the client corresponding to the second communication account may be the client used by the second communication account to login in the server of the second communication type.

Through steps above, the information transmission between communication accounts of different types can be realized. For example, when the first communication is of instant communication type and the second communication is of telephone type, an instant communication account can transmit information to a telephone account (for example: telephone number). Practically, it is free to transmit information on a communication account of instant communication type, while not on that of telephone type. Through steps above, it will be free of charge to transmit information to telephone account (for example, telephone number). Besides, in practical application, information of telephone account (for example, telephone number) always draws much more attention than that of instant communication account. Therefore, it enables users to view information instantly by transmitting information to telephone account (for example, telephone number) through steps above.

The technical scheme comprises steps of: logining, by a client, into a server of the first communication type through the first communication account; getting, by the client, the second communication account of the second communication type, in which the second communication account is not in friend list of the first communication account and may not accept invitation request from the client; receiving, from a user interface, by the client, the first information which is input by the user using the user interface and carries the second communication account; transmitting, the client, the first information to the server, and transmitting, by the server, the first information to the client corresponding to the second communication account. Thus, communication transmission between the first communication account and the second communication account is realized and it is now possible to transmit information between communication accounts of different types and meet the requirement of users.

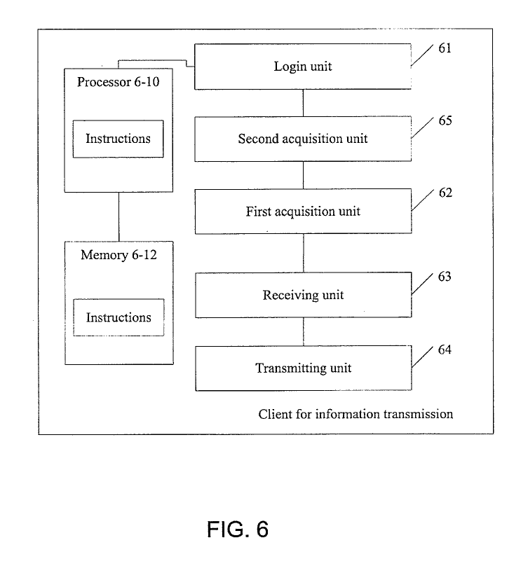

FIG. 6 shows the structural diagram of another client for information transmission provided by the examples of this disclosure. As shown in FIG. 6, the client is composed with a login unit 61, a first acquisition unit 62, a receiving unit 63 and a transmitting unit 64. Units shown in FIG. 6 may have one or more processors 6-10 to execute instructions stored in memory 6-12.

The login unit 61 is used to login into a server of the first communication type through the first communication account.

The first acquisition unit 62 is used to get the second communication account of the second communication type in case of default situation, wherein the second communication account is not in friend list of the first communication account and may not accept invitation request from the client.

Preferably and specifically, the default situation may be the situation in which; the client receives an indication message that the third communication account in friend list of the first communication account may not accept information; the second communication account and the third communication type are communication accounts of the second communication type, which are registered by a same user and not in friend list of the first communication account, and may not accept invitation request from the client, or, the client transmits a second information to the forth communication account in friend list of the first communication account and starting timing; and the client does not accept the response information returned by the forth communication account within the preset time period, or the second communication account transmits the first information in an emergency.

Preferably, the client may also include a second acquisition unit 65.

The second acquisition unit 65 is used to get an indication message indicating that the third communication account in friend list of the first communication account may not accept information; and the second communication account and the third communication type are communication accounts of the second communication type, in which the communication accounts are registered by a same user and not in friend list of the first communication account, and may not accept invitation request from the client. Specifically, the indication message may be obtained in measurement of the client, or transmission from the server to the client.

Therefore, it can transmit the first information, which is under transmission to the third communication account, to the second communication account of the user, in case that the third communication account may not accept information, for example, in case that the user does not use the third communication account to login in the server, or there is network anomaly on the third communication account, but network of the second communication account is normal. For example, the user at a terminal uses the third communication account (for example: an instant communication account) to login in the server through wireless network, and logins in the server of the second communication type through mobile network using the second communication account (for example: mobile phone number). In case anomaly happens to the wireless network and the third communication account (for example: an instant communication account) may not accept information, the example can transmit the first information to the second communication account (for example: mobile phone number), namely the user is enabled to receive the first information.

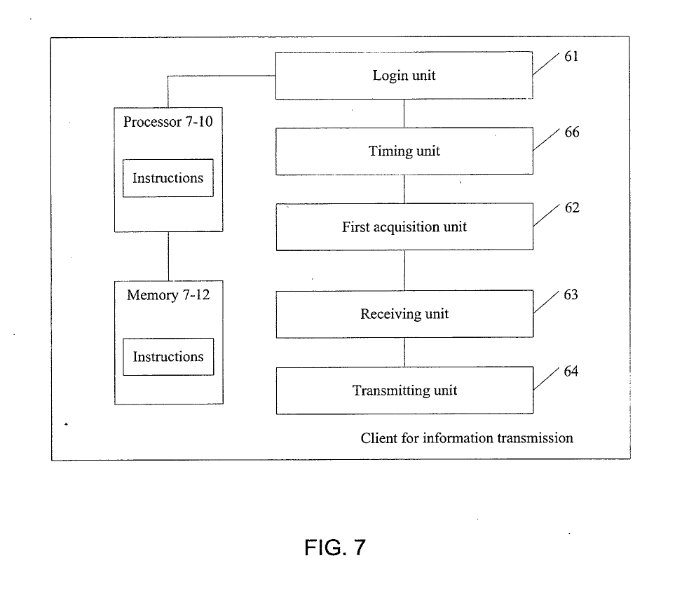

Preferably, as shown in FIG. 7, the client may also contain a timing unit 66. The timing unit 66 is used to transmit the second information to the forth communication account in friend list of the first communication account and start timing. The first acquisition unit 62, which may be also used to execute the step of the client getting a second communication account of the second communication type, in which the second communication account is not in friend list of the first communication account and may not accept invitation request, in case that the client may not accept the response information returned by the forth communication account within the preset time; in which, the second communication account and the forth communication account are communication accounts registered by a same user.

Units shown in FIG. 7 may have one or more processors 7-10 to execute instructions stored in memory 7-12.

Therefore, the first acquisition unit 62 executes the step of getting the second communication account in case that the forth communication account does not return the response information within a certain time. For example, in case that no response information returned from the forth communication account is received within 1 minute after the second information is transmitted to the forth communication account, the first acquisition unit 62 will get the second communication account above. For example, a user logins in the second communication account and the forth communication account at a same time, but the user may be using the client corresponding to the second communication account, rather than that corresponding to the forth communication account, the user can receive the first information using the client corresponding to the second communication account.

Preferably, the first acquisition unit 62 is also used to get a locally stored second communication account of the second communication type, in which the second communication account is not in friend list of the first communication account and may not accept invitation request.

For example, in the step of getting the second communication account in contact of the terminal in which the client locates, the client displays the contact interface of the terminal, in which the client locates, and then receives the second communication account selected on the interface by user.

Preferably, the first acquisition unit 61 may be also used to get an online second communication account of the second communication type, in which the second communication account is not in friend list of the first communication account and may not accept invitation request.

For example, it gets a second communication account transmitted by friend of the first communication account, or the client receives the second communication account transmitted by the server. Of course, the second communication account may be a communication account input by user.

The receiving unit 63 is used to receive the first information which is input by the user and carries the second communication account.

Preferably, the receiving unit 63 is also used to display a dialogue interface for communication with the second communication account, and receive the first information which is input by the user on the interface and carries the second communication account.

Therefore, information transmission to the second communication account will be same to that to friend account of the first communication account and this simplifies the operation of user.

The transmitting unit 64 is used to transmit the first information to the server so that the server transmits the first information to the client corresponding to the second communication account.

Various optional execution modes are introduced on basis of the examples above in the technical scheme, all of which can realize information transmission between communication accounts of different types, and meet requirement of users.

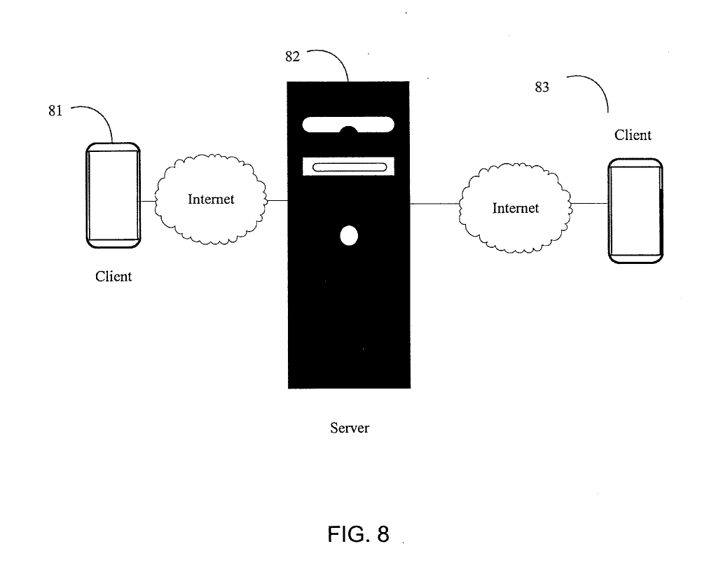

FIG. 8 shows the structural diagram of a system for information transmission provided by the examples of this disclosure. It is composed by a client 81 and a server 82. The server 82 is a server of the first communication type.

The client 81 is used to login into a server of the first communication type through the first communication account; get the second communication account of the second communication type, in which the second communication account is not in friend list of the first communication account and may not accept invitation request from the client; receive the first information which is input by the user and carries the second communication account; and transmit the first information to the server 82.

Preferably, the information above may be text information, image information, audio information and the like, which is not limited in the example.

The server 82 is used to transmit the first information to the client corresponding to the second communication account.

Preferably, when the server 82 receives the information above, it will transmit the information to the client corresponding to the second communication account. Specifically, the server 82 transmits the first information to the server 82 of the second communication type, and then the server 82 transmits the information to the client corresponding to the second communication account.

Preferably, the client 81 is also used to get an indication message indicating that the third communication account in friend list of the first communication account may not accept information; and the second communication account and the third communication type are communication accounts of the second communication type, in which the communication accounts are registered by a same user and not in friend list of the first communication account, and may not accept invitation request from the client.

Preferably, the client 81 is also used to transmit the second information to the forth communication account in friend list of the first communication account and start timing; and execute the step of the client getting the second communication account of the second communication type, in which the second communication account is not in friend list of the first communication account and may not accept invitation request, in case that the client may not accept the response information returned by the forth communication account within the preset time; in which, the second communication account and the forth communication account are communication accounts registered by a same user.

Preferably, the client 81 is used to get a locally stored second communication account of the second communication type, in which the second communication account is not in friend list of the first communication account and may not accept invitation request.

Preferably, the client 81 is used to get an online second communication account of the second communication type, in which the second communication account is not in friend list of the first communication account and may not accept invitation request.

Preferably, client 81 is also used to display a dialogue interface for communication with the second communication account, and receive the first information which is input by the user on the interface and carries the second communication account.

Preferably, the system may also include the client 83 used by the second communication account to login in server of the second communication type. Namely, after the server 82 receives the information above, it will transmit the information to the client 83.

The technical scheme above comprises steps of: logining, by a client, into a server of the first communication type through the first communication account; getting, by the client, the second communication account of the second communication type, in which the second communication account is not in friend list of the first communication account and may not accept invitation request from the client; receiving, the client, the first information which is input by the user and carries the second communication account; transmitting, by the client, the first information to the server; and transmitting, by the server, the first information to the client corresponding to the second communication account. Thus, communication transmission between the first communication account and the second communication account is realized and it is now possible to transmit information between communication accounts of different types and meet the requirement of users.

Persons of skill in the art can get aware that the whole or part of the method in the examples above may be realized through relevant hardware under instruction of computer program, in which the program may be stored in a computer-readable memory medium. When the program is executed, flow processes in examples of processes above may be contained. Therein, the memory medium above may be diskette, optical disk, Read-Only Memory (ROM) or Random Access Memory (RAM), or the like.

All disclosures above are the preferred examples of this disclosure, which are not intending to limit range of the disclosure.

What is claimed is:

1. A method for information transmission, comprising:
logging in, through a first communication account by a client with a processor, to a server handling a first communication type;
obtaining, by the client with the processor, a second communication account corresponding to a second communication type wherein the second communication account is not in a friend list of the first communication account and does not accept an invitation request from the client;
receiving, from a user interface, by the client with the processor, first information carrying the second communication account wherein the first information is input by a user using the user interface; and
transmitting, by the client with the processor, the first information to the server for the server to transmit the first information to the client corresponding to the second communication account.

2. The method of claim 1, further comprising:
prior to obtaining the second communication account of the second communication type, getting, by the client, an indication message indicating that a third communication account in the friend list of the first communication account cannot accept information; and
wherein the second communication account and the third communication account are registered by a same user, and the second communication account is not in the in the friend list of the first communication account and does not accept the invitation request, sent by the client, for the communication account of the second communication type.

3. The method of claim 1, further comprising:
prior to getting the second communication account of the second communication type, transmitting, by the client, second information to a fourth communication account in the friend list of the first communication account and starting timing;
in case that the client cannot accept response information returned by the fourth communication account within a preset time, executing the step of the getting the second communication account; wherein the second communication account and the fourth communication account are registered by a same user.

4. The method of claim 1, wherein the getting the second communication account comprises;
getting, by the client, a locally stored second communication account of the second communication type; or
getting, by the client, an online second communication account of the second communication type.

5. The method of claim 1, wherein the receiving the first information comprises:
displaying, by the client, a dialogue interface for communication with the second communication account.

6. A client for information transmission, comprising:
one or more processors, a memory, a login unit, a first acquisition unit, a receiving unit and a transmitting unit, wherein:
the login unit having the one or more processors coupled with the memory that is used to login into a server of a first communication type through a first communication account;
the first acquisition unit having the one or more processors coupled with the memory that is used to get a second communication account of a second communication type wherein the second communication account is not in a friend list of the first communication account and does not accept an invitation request from the client;
the receiving unit having the one or more processors coupled with the memory that is used to receive first information from a user interface carrying the second communication account wherein the first information is input by a user using the user interface; and
the transmitting unit having the one or more processors coupled with the memory that is used to transmit the first information to the server for the server transmitting the first information to the client corresponding to the second communication account.

7. The client of claim 6, further comprising:
a second acquisition unit having the one or more processors coupled with the memory that is used to get an indication message indicating that a third communication account in the friend list of the first communication account cannot accept information; and
wherein the second communication account and the third communication type are registered by a same user, and the second communication account is not in the in the friend list of the first communication account and does not accept the invitation request, sent by the client, for the communication account of the second communication type.

8. The client of 6, further comprising:
a timing unit having the one or more processors coupled with the memory that is used to transmit second information to a fourth communication account in the friend list of the first communication account and start timing; and
in case that the client does not accept the response information returned by the fourth communication account within a preset time, the first acquisition unit is used to get a second communication account of a second communication type wherein the second communication account is not in a friend list of the first communication account and does not accept an invitation request from the client; wherein the second communication account and the fourth communication account are registered by a same user.

9. The client of claim 6, wherein the first acquisition unit is further used to:
get a locally stored second communication account of the second communication type; or
get an online second communication account of the second communication type.

10. The client of claim 6, wherein the receiving unit is further used to:
display a dialogue interface for communication with the second communication account.

11. A system for information transmission, comprising: a client with one or more processors coupled with a memory and a server with one or more processors coupled with a memory, wherein:
the client is used to:
login into the server of a first communication type through a first communication account,
get a second communication account of a second communication type, wherein the second communication account is not in a friend list of the first communication account and has does not accept an invitation request from the client,
receive first information from a user interface carrying the second communication account wherein the first information is input by a user using the user interface, and transmit the first information to the server; and
the server is used to:
transmit the first information to the client corresponding to the second communication account.

12. The system in accordance with claim 11, wherein the client is also used to:
get an indication message that a third communication account in the friend list of the first communication account cannot accept information; and
wherein the second communication account and the third communication type are registered by a same user, and the second communication account is not in the in the friend list of the first communication account and does not accept the invitation request, sent by the client, for the communication account of the second communication type.

13. The system of claim 11, wherein the client is further used to:
transmit second information to a fourth communication account in the friend list of the first communication account and start timing; and
in case that the client cannot accept response information returned by the fourth communication account within a preset time, get the second communication account of the second communication type, wherein the second communication account and the fourth communication account are registered by a same user.

14. The system of claim 11, wherein the client is used to:
get a locally stored second communication account of the second communication type; or
get an online second communication account of the second communication type.

15. The system of claim 11, wherein the client is further used to:
display a dialogue interface for communication with the second communication account and receive the first information.
